(19) United States
(12) Patent Application Publication
(10) Pub. No.: US 2024/0397385 A1
(43) Pub. Date: Nov. 28, 2024

(54) SYSTEM AND METHODS FOR DYNAMIC COORDINATION OF PHASES IN ULTRA-WIDEBAND COMMUNICATION

(71) Applicant: Qorvo US, Inc., Greensboro, NC (US)

(72) Inventors: Eric Perraud, Toulouse (FR); Guillaume Vivier, Toulouse (FR)

(21) Appl. No.: 18/646,524

(22) Filed: Apr. 25, 2024

Related U.S. Application Data
(60) Provisional application No. 63/504,304, filed on May 25, 2023.

(51) Int. Cl. H04W 28/18; H04W 72/0446; H04W 72/543

(52) U.S. Cl. CPC H04W 28/18; H04W 72/0446; H04W 72/543

(57) ABSTRACT

A method for scheduling control in UWB communication is provided. The method includes transmitting a first control message at a beginning of a first communication period to a UWB device, the first control message indicating a first slot allocation to the UWB device for the first communication period. The method also includes receiving, from the UWB device, a scheduling information message indicating an estimated number of slots needed for a second communication period subsequent to the first communication period. The method also includes determining a second slot allocation to the UWB device based on the estimated number of slots needed. The method further includes transmitting a second control message, at a beginning of the second communication period, to the UWB device, the second control message indicating the second slot allocation to the UWB device for the second communication period.

### RELATED APPLICATIONS

This application claims priority to U.S. Provisional Patent Application No. 65/504,304 filed May 25, 2023, which is incorporated by reference herein in its entirety

### FIELD OF THE DISCLOSURE

The present disclosure relates to ultra-wideband-enabled devices and systems for facilitating dynamic coordination of phases in ultra-wideband (UWB) communication, in particular, to wireless sales payment solutions that enables an optimization of the coordination of phases in hybrid ranging rounds to reduce conflicts and interferences, and reduce payment time.

### BACKGROUND

Ultra-wideband (UWB) is a radio technology that is able to use a very low energy level for short-range, high-bandwidth communications over a large portion of the radio spectrum. For example, UWB technology can be used in ranging, which is a process of determining the distance between two devices using UWB technology. UWB technology can also be used in short-range data transactions. Today, UWB technology is used in various applications that involve short-range ranging and data transactions, such as, for example, contactless payment at point of sales (POS's).

Hybrid scheduling is used to coordinate the scheduling of slots for the multiple UWB devices at different POS's. A UWB device is installed at a POS and can receive payments from UWB-enabled users. An UWB coordinator of the hybrid scheduling allocates the slots to each UWB device at the beginning of a hybrid ranging round. In the hybrid ranging round, each UWB device performs a series of actions in the allocated slots. A payment can be completed in one or more hybrid ranging rounds. For example, a UWB device often performs three steps in a hybrid ranging round, each in a phase (e.g., a sub-session) of one or more slots. The first step is contention-based phase (or contention access period “CAP”) for discovering new UWB users, and the second step is a time scheduled secured ranging phase (e.g., a two-way ranging (TWR) or contention free period “CFP”) to range one or more UWB users that have been discovered in the CAP phase. The third step is an in-band data phase (e.g., a data phase) which typically is an in-band authentication transaction for previously ranged users to make payments. By repeating the hybrid ranging rounds, user devices at different POSs can make payments to their respective UWB devices.

However, challenges still exist. For example, some of the POSs can become more crowded with user devices than others. The allocated slots for a phase of a UWB device at a more crowded POS in a hybrid ranging round may not be sufficient for the UWB device to accommodate an increased number of user devices, while the slots allocated to a UWB device at a less crowded POS may be left unused. Thus, coordination that can optimize the slot allocations for the UWB devices is needed.

### SUMMARY

Embodiments of the disclosure provide a method for scheduling control in UWB communication. The method includes transmitting a first control message at a beginning of a first communication period (also called round) to a UWB device, the first control message indicating a first slot allocation to the UWB device for the first communication period. The method also includes receiving, from the UWB device, a scheduling information message indicating an estimated number of slots needed for a second communication period (e.g., round) subsequent to the first communication period. The method also includes determining a second slot allocation to the UWB device based on the estimated number of slots needed. The method further includes transmitting a second control message, at a beginning of the second communication period, to the UWB device, the second control message indicating the second slot allocation to the UWB device for the second communication period.

In some embodiments, the determining of the second slot allocation to the UWB device includes one of: reducing a number of slots allocated to the UWB device in response to the estimated number of slots needed indicating a decrease of a slot usage; increasing the number of slots allocated to the UWB device in response to the estimated number of slots needed indicating an increase of the slot usage; or maintaining the number of slots allocated to the UWB device in response to the estimated number of slots needed being zero.

In some embodiments, the first communication period and the second communication period each includes a first period for the UWB device to detect a new user device, a second period for the UWB device to perform ranging with an existing user device, and a third period for the UWB device to perform data transfer with another existing user device; the first slot allocation includes a command to allocate respective slots for the first period, the second period, and the third period in the first communication period; and the second slot allocation includes a command to allocate updated respective slots for the first period, the second period, and the third period in the second communication period.

In some embodiments, the scheduling information message includes the estimated number of slots needed based on an estimated number of user devices in one or more of the first period, the second period, or the third period in the second communication period.

In some embodiments, the first control message further includes an allocation of a slot to the UWB device for the transmission of the scheduling information message.

In some embodiments, the second slot allocation includes a command to reduce a number of slots allocated to the first period in the second communication period in response to the estimated number of slots needed exceeding a largest number of slots that can be added to the second communication period.

In some embodiments, the method further includes, after transmitting the first control message and before receiving the scheduling information message, detecting a second UWB device; and receiving configuration information of the UWB device from a non-UWB channel. The second control message further indicates a slot allocation to the second UWB device for the second communication period.

Embodiments of the present disclosure provide a method for scheduling control in UWB communication. The method includes receiving a control message, at a beginning of a first communication period, from a UWB device, the control message indicating a first slot allocation to the UWB device for the first communication period; allocating slots in the first communication period according to the control message; determining an estimated number of slots needed for a second communication period subsequent to the first communication period; and transmitting, to the UWB device, a scheduling information message indicating the estimated number of slots needed for the second communication period.

In some embodiments, the method further includes receiving a second control message at a beginning of the second communication period, from the UWB device, the control message indicating a second slot allocation for the second communication period, the second slot allocation reflecting the estimated number of slots needed; and allocating slots in the second communication period according to the second control message.

In some embodiments, the second control message includes a command for, reducing a number of slots allocated to the UWB device in response to the estimated number of slots needed indicating a decrease of a slot usage; increasing the number of slots allocated to the UWB device in response to the estimated number of slots needed indicating an increase of the slot usage; or maintaining the number of slot s allocated to the UWB device in response to the estimated number of slots needed being zero.

In some embodiments, the first communication period and the second communication period each includes a first period for detecting a new user device, a second period for performing ranging with an existing user device, and a third period for performing data transfer with another existing user device; the first slot allocation includes a command to allocate respective slots for the first period, the second period, and the third period in the first communication period; and the second slot allocation includes a command to allocate updated respective slots for the first period, the second period, and the third period in the second communication period.

In some embodiments, the scheduling information message is transmitted after the third period of the first communication period or at an end of the first communication period.

In some embodiments, the determining of the estimated number of slots needed for the second communication period includes, determining a number of user devices that are active in at least one of the first period, the second period, or the third period of the first communication period; estimating a number of user devices that are active in at least one of the first period, the second period, or the third period of the second communication period based on the number of user devices that are active in the first communication period; and determining an estimated number of slots for at least one of the first period, the second period, or the third period of the second communication period based on the estimated number of user devices that are active in the at least one of the first period, the second period, or the third period of the second communication period.

In some embodiments, the determining of the estimated number of slots for at least one of the first period, the second period, or the third period of the second communication period includes determining the estimated number slot that is greater than or equal to the number of user devices that are active in a respective period in the first communication period, and less than or equal to a maximum number of slots for the respective period.

In some embodiments, the scheduling information message includes an indication to terminate communication with the UWB device; and the second control message includes a command to remove a communication identification.

Embodiments of the present disclosure provide a UWB device. The UWB device includes a transceiver operable to perform a UWB communication, and a memory for storing program instructions, communication identification of another UWB device, and slot allocation for the other UWB device. The UWB device also includes a processor coupled to the transceiver and to the memory. The processor is operable to execute the program instructions, which, when executed by the processor, cause the UWB device to perform the following operations to allocate slots for a subsequence communication period for the other UWB device: Transmitting a first control message, at a beginning of a first communication period, to a UWB device, the first control message indicating a first slot allocation to the other UWB device for the first communication period; Receiving, from the other UWB device, a scheduling information message indicating an estimated number of slots needed for a second communication period subsequent to the first communication period; Determining a second slot allocation to the other UWB device based on the estimated number of slots needed; and Transmitting a second control message, at a beginning of the second communication period, to the other UWB device, the second control message indicating the second slot allocation to the other UWB device for the second communication period.

In some embodiments, the determining of the second slot allocation to the other UWB device includes one of the following: reducing a number of slots allocated to the other UWB device in response to the estimated number of slots needed indicating a decrease of a slot usage; increasing the number of slots allocated to the other UWB device in response to the estimated number of slots needed indicating an increase of the slot usage; or maintaining the number of slots allocated to the other UWB device in response to the estimated number of slots needed being zero.

In some embodiments, the first communication period and the second communication period each includes a first period for the other UWB device to detect a new user device, a second period for the other UWB device to perform ranging with an existing user device, and a third period for the other UWB device to perform data transfer with another existing user device. In some embodiments, the first slot allocation includes a command to allocate respective slots for the first period, the second period, and the third period in the first communication period. In some embodiments, the second slot allocation includes a command to allocate updated respective slots for the first period, the second period, and the third period in the second communication period.

In some embodiments, the scheduling information message includes an estimated change of a number of user devices in one or more of the first period, the second period, or the third period in the second communication period.

In some embodiments, the first control message further includes an allocation of a slot to the other UWB device for the transmission of the scheduling information message.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1A illustrates exemplary ultra-wideband (UWB) devices and an exemplary system for implementing dynamic coordination, according to some aspects of the present disclosure.

FIG. 1B illustrates an exemplary environment with a system in which UWB technology is envisioned to be used to enable dynamic coordination of slot allocation to reduce conflicts and payment time, according to some aspects of the present disclosure.

FIG. 1C illustrates a signaling diagram in which a primary controller discovers a new secondary controller, according to some aspects of the present disclosure.

FIG. 2 illustrates an existing hybrid ranging round.

FIGS. 3A-3C each illustrates an exemplary hybrid ranging round for implementing dynamic coordination, according to some aspects of the present disclosure.

FIGS. 4 and 5 each illustrates a signaling diagram in which a secondary controller communicates with the primary controller for implementing dynamic coordination, according to some aspects of the present disclosure.

FIGS. 6A and 6B illustrate signaling diagrams the primary controller adjusts the slots allocated to a secondary controller for implementing dynamic coordination, according to some aspects of the present disclosure.

FIG. 7A illustrates an exemplary ranging control message (RCM) for implementing dynamic coordination according to some aspects of the present disclosure.

FIG. 7B illustrates an exemplary scheduling information message (SIM) for implementing dynamic coordination according to some aspects of the present disclosure.

FIG. 8A illustrates an exemplary method for a primary controller to implement dynamic coordination, according to some aspects of the present disclosure.

FIG. 8B illustrates an exemplary method for a secondary controller to implement dynamic coordination, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known, also referred to as anchor devices). The present disclosure assumes that the user is carrying a device capable of communicating through UWB (referred to as “UWB-enabled user device” or simply “user device”).

As previously described, in a shop of POSs (e.g., POS 1, POS 2, POS 3, . . . , etc.), a UWB device is installed at each POS to receive and process payments through contactless payment. To avoid collision between payment transactions done with 2 different POSs, a coordinator of all UWB devices is deployed in a given area (e.g., part of the shop or the entire shop). The coordinator can be one of the UWB devices installed at POSs, or can be a separate dedicated device that supports UWB communication. The coordinator is often elected before the beginning of a hybrid ranging session. The coordinator often allocates slots to a CAP phase, a CFP phase, and a data phase of a UWB device installed at a respective POS at the beginning of a hybrid ranging round based on a static coordination (e.g., allocating a default/predetermined number of slots to each of the phases). But this a-priori allocation of slots per sessions has some drawbacks. For example, UWB device at POS 1 may have multiple customers and may not have enough allocated slots to handle all of them. In another example, POS 2 may have discovered 8 customers in previous hybrid ranging rounds and need 12 slots for a secure TWR ranging, while it has only 5 slots, which is the default number of slots allocated for a TWR secure ranging for only one user. In another example, POS 3 does not have any customer and its slots would be wasted, although they can be used if they were allocated to the UWB devices at POS 1 and/or POS 2. There is a risk of bottleneck at UWB devices at some POSs, while the UWB devices at other POSs may be idle. As a result, the transactions between a user and a UWB device can be limited due to the static slot allocation. For example, a UWB device may not be able to detect all the users around it because of an undesirably small CAP size (e.g., the number of slots in the CAP phase), or it can't securely range all the discovered users in one round due to an undesirably small CFP size (e.g., the number of slots in the CFP phase). The authentication transactions (e.g., data transfers) can be delayed. In other words, the payment time may be longer due to the bottlenecks caused by the static slot allocation, and the user can have poor user experience.

Therefore, it is beneficial to have a feedback system between a UWB device and the coordinator. For example, the UWB devices installed at POSs can inform the coordinator about its slot needs for future scheduling, and the coordinator can address the needs accordingly. In an example, a UWB device may inform the coordinator whether it needs slots for a CFP phase in a future/next hybrid ranging round (and how many, depending on the number of user devices in its current CFP phase), whether it needs slots for its data phase in a future hybrid ranging round (and how many, depending on the delay between the requests and the responses of different user devices), and how many slots it needs for its CAP phase in a future hybrid ranging round (e.g., if it detects multiple collisions, it may request more slots for its CAP).

Embodiments of the present disclosure provide system and methods for dynamic coordination of phases that optimizes slot allocations amongst UWB devices installed at multiple POS's (e.g., in a shop). Using the disclosed system and methods, slots for each UWB devices are dynamically adjusted based on their needs (e.g., the number of user devices and activities at the POS) of the UWB device. A UWB device, as a secondary controller, e.g., a controller that controls the respective phases in a hybrid ranging round, may determine an estimated number of slots needed for the next hybrid ranging round based on the number of user devices and/or activities in the current hybrid ranging round, and send a slot information message (SIM) at the end of a hybrid ranging round to the coordinator. Specifically, the UWB device can determine the estimated number of slots needed for one or more of the CAP phase, the CFP phase, and the data phase in the next hybrid ranging round based on the user number/activities of one or more of these phases in the current hybrid ranging round. The SIM indicates the request for the estimated number of slots needed for the next future hybrid ranging round. The coordinator, as the primary controller, e.g., a controller that controls the secondary controllers, may then determine a new slot allocation for the UWB device based on the SIM, and allocate the slots according to the new allocation at the beginning of the next hybrid ranging round. The SIM may be an in-band UWB message but may also be sent back to the coordinator via Out-Of-Band connections like BLE (Bluetooth Low Energy).

Also, the present disclosure provides a ranging control message (RCM) and the SIM. The RCM, sent by the coordinator at the beginning of a hybrid ranging round, is employed to allocate slots for the UWB device(s). For example, the RCM may include allocation of an updated number of slots for the CAP, CFP, and data phases of the UWB device, as well as the slot allocation for the SIM of the UWB device if it is an in-band UWB message. The SIM, sent by the UWB device, may include the estimated number of slots needed for each of the CAP phase, the CFP phase, and the data phase for the next hybrid ranging round. By using the RCM and SIM, a feedback mechanism may be implemented between the coordinator and the UWB devices, allowing the coordinator to dynamically adjust the number of slots allocated amongst the UWB devices to optimize coordination, reduce conflict and interferences, reduce payment time, and improve user experience. In some embodiments, the RCM is an enhanced RCM T3 compared to an existing RCM T3.

The disclosed methods and systems can facilitate several improvements. For example, the methods and system allow scalable deployment of multiple UWB devices by providing coordination of multiple phases. Dynamic adaptation of various phases controlled by the coordinator is provided. The methods and system also allow the UWB devices (e.g., secondary controllers) to signal their needs to the coordinator and the coordinator to dynamically adjust the slot allocation to the actual needs. In a UWB payment environment, the system and methods can reduce the duration of the full payment transaction and allow a seamless payment procedure even if the UWB device at one POS is heavily loaded with multiple users. Further, the methods and system can support any type of payment applications and do not assume high performance applications with a short delay request/response delay.

In this disclosure, the terms “coordinator” and “primary controller” can be used interchangeably; the terms “controlee” and “secondary controller” can be used interchangeably. For case of illustration, possible intervals between phases (or sub-sessions) are not shown in the figures. In this disclosure, each of “phase,” a “sub-session,” a “hybrid ranging round,” and “a hybrid ranging session” includes a period of time, and can each be used interchangeably with “time period” when necessary In some embodiments, a sub-session is interchangeable with a phase. In some embodiments, a hybrid session includes one or more hybrid ranging rounds which occur periodically. In some embodiments, a ranging round may include one or more sub-sessions.

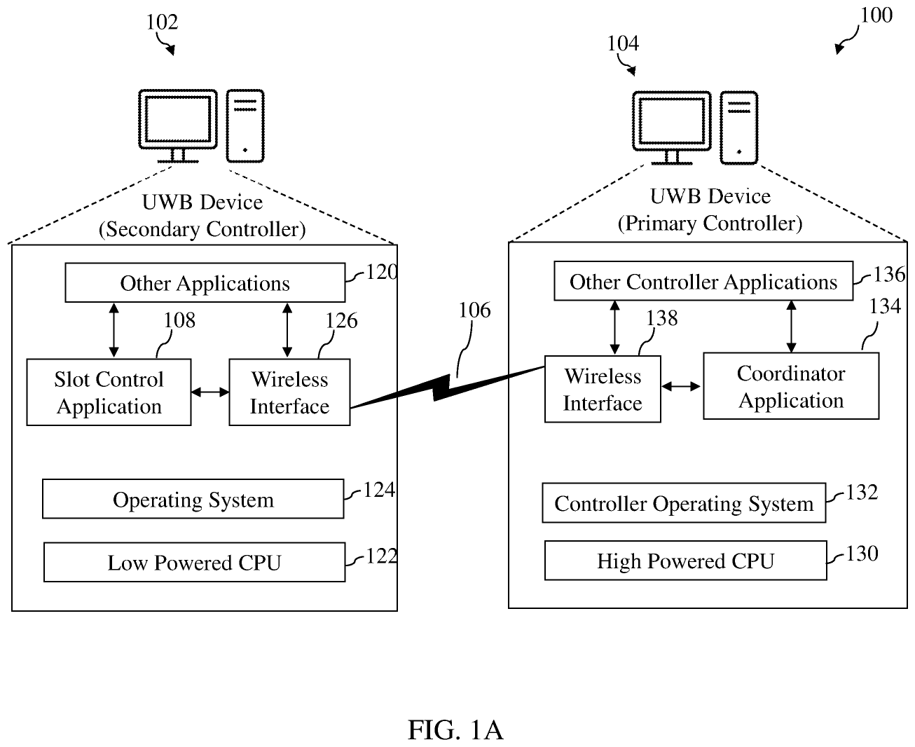

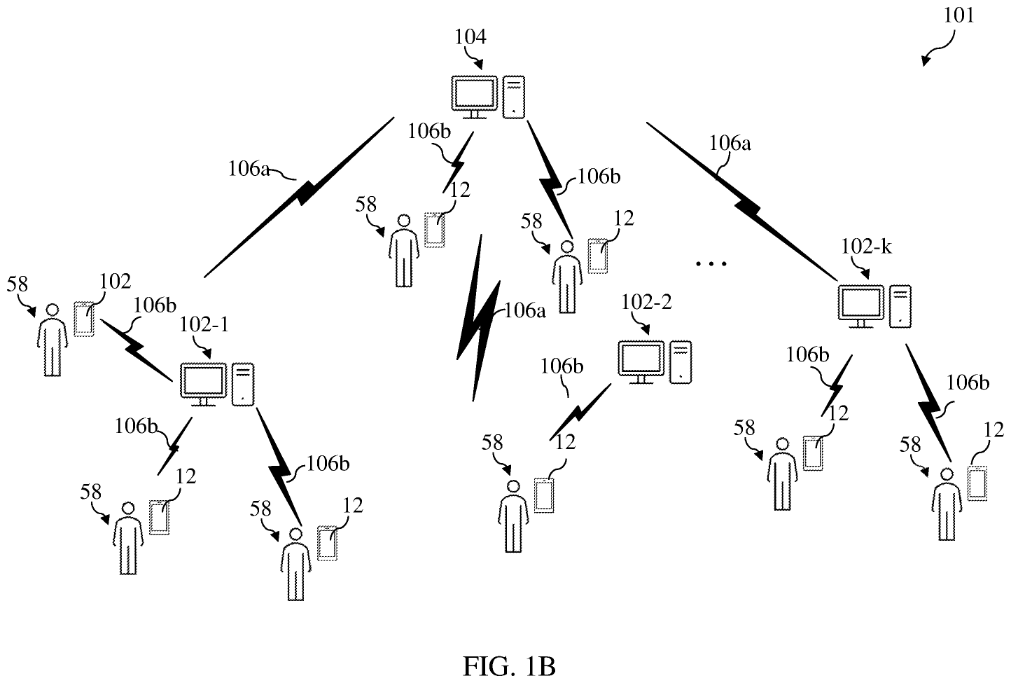

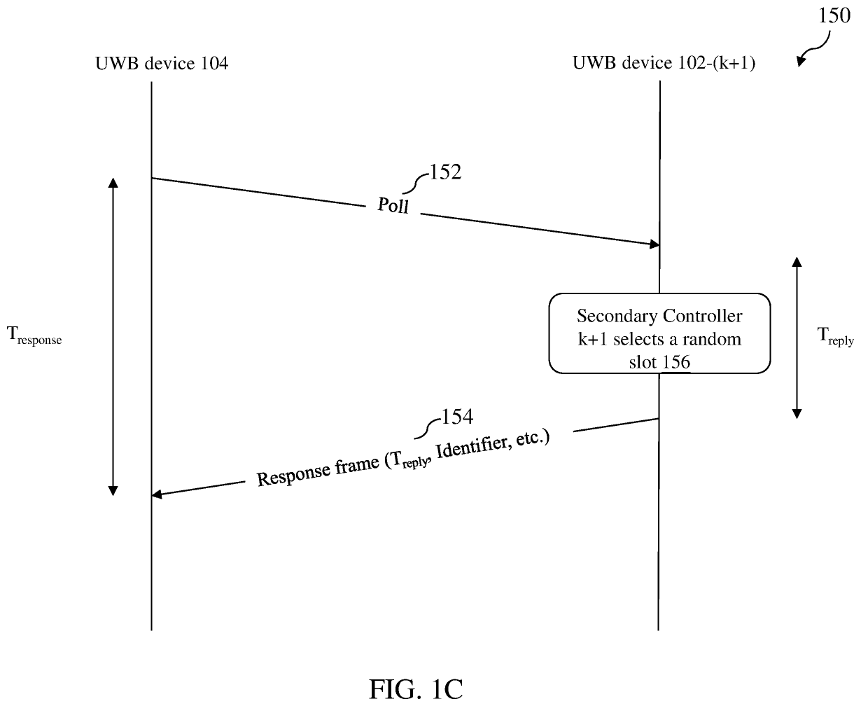

FIG. 1A depicts an exemplary system 100 for implementing the dynamic coordination according to one embodiment of the present disclosure. System 100 may include a UWB device 102 that is in wireless communication with another UWB device 104, as symbolically illustrated by a wireless link 106. UWB device 102 may be installed at a POS, and can be a mobile device or an on-board computer. It is noted here that the terms “mobile device,” “mobile handset,” “wireless handset,” and “User Equipment (UE)” may be used interchangeably hereinbelow to refer to a wireless communication device that is capable of voice and/or data communication. Some examples of such mobile handsets include smartphones, tablets, and wearable devices. UWB device 102 may be referred to as a secondary controller that controls the UWB communication in designated slots in a hybrid ranging round. UWB device 102 may perform a CAP phase, a CFP phase, and/or a data phase in a hybrid ranging round.

UWB device 104 may be referred to as the primary controller that controls the slot allocation to each secondary controller (e.g., UWB device 102). UWB device 104 may or may not be a separate computing unit (in hardware or software form) dedicated to carry out the coordination amongst secondary controllers. In some embodiments, UWB device 104 may be installed at a POS and may also perform a CAP phase, a CFP phase, and/or a data phase in a hybrid ranging round, similar to UWB device 102. In some embodiments, UWB device 104 may be a computing unit (e.g., laptop, desktop, mobile phone, tablet, etc.) dedicated for the coordination function, and may or may not be installed at a POS. In one embodiment, the functionality of the UWB device 104 may be implemented in an already-existing physical computing/data processing unit or (nonphysical) server software in a cloud. Wireless link 106 may include a UWB communication interface. The wireless link 106 may also support other types of wireless connections, such as a Bluetooth communication interface, a Wi-Fi communication interface, a cellular network connection (e.g., 4G, 5G) interface, a near field communication (NFC) interface, a ZigBee communication interface, or a combination thereof.

A slot control application 108 is one of the mobile applications installed in the UWB device 102. Slot control application 108 may include suitable software and/or hardware to determine the estimated slot change/needs for future (e.g., next) hybrid ranging round based on the number of user devices and/or activities in the phases of the current hybrid ranging round. In some embodiments, slot control application 108 generates and sends a SIM, via wireless interface 126, to UWB device 104 to report a change in slot use in a future (e.g., the next) hybrid ranging round. In some embodiments, slot control application 108, upon receiving a RCM from UWB device 104 that allocates slots, may allocate the slots for the phases of the current hybrid ranging round according to the RCM. In addition to slot control application 108, the UWB device 102 may also include one or more applications 120 reside therein. These applications 120 are software modules that may have been pre-packaged with the UWB device 102 or may have been downloaded by a user into the memory (not shown) of the UWB device 102. Some applications 120 may be more user-interactive applications, whereas some other mobile applications, such as slot control application 108, may be less user-interactive in nature. For example, some applications include Ethernet-based communication, an application that interacts with cloud, etc. In some embodiments, UWB device 102 is a mobile device and applications 120 may include mobile applications. The applications 120 as well as slot control application 108 may be executed by the processor 122 under the control of the mobile operating system 124. In some embodiments, processor 122 may be designed to conserve battery power, such as a relatively low-powered Central Processing Unit (CPU). UWB device 102 may further include a wireless interface unit 126 to facilitate wireless communication with the UWB device 104 via the wireless link 106. The applications 108, 120 may utilize the wireless interface 126 as needed.

UWB device 104 is shown to include a CPU 130 executing a controller operating system 132. In some embodiments, CPU 130 is relatively high-powered. UWB device 104 may include a coordinator application 134 that process the SIM and determines the updated slot allocation for the future (e.g., next) hybrid ranging round. Coordinator application 134 may then send a RCM, through wireless interface 138, to UWB device 102 at the beginning of the future (e.g., next) hybrid ranging round. The RCM may include the updated slot allocation for the future hybrid ranging round. In addition to coordinator application 34, UWB device 104 may also store in its memory (not shown) other controller-specific applications 136 such as, for example, an application that facilitates Ethernet-based communication, an application that interacts with cloud, and the like. The UWB device 104 may wirelessly communicate with the UWB device 102 via its own wireless interface unit 138. The wireless interface units 126 and 138 may wirelessly transfer data or information between the UWB device 102 and the UWB device 104 using the wireless link 106 as shown.

FIG. 1B shows an illustrative environment 101 for dynamic coordination that enables optimization of slot allocation and reduces conflicts interferences, and payment time with UWB devices. Particularly, in the illustrative embodiment, system 100 is implemented in the UWB devices in environment 101, e.g., a shop of multiple UWB devices. Environment 101 includes a UWB device 104 (e.g., the primary controller or coordinator) and one or more UWB devices 102 (e.g., 102-1, . . . , 102-k, k being at least 1). Each of UWB devices 102-1, . . . , 102-k may be a secondary controller and may listen to and be coordinated by the UWB device 104 (e.g., the primary controller).

UWB device 104 may bi-directionally communicate with UWB devices 102-1, . . . , 102-2 through wireless links 106-a. A user 58, carrying a user device 12, can bi-directionally communicate with a UWB device (e.g., a secondary controller or the primary controller) installed at a nearby POS to make payments using user device 12. User device 12 may include a CPU, a memory, an Operating system, a UWB chip, and a wireless interface. User device 12 may establish a wireless link 106b (e.g., UWB channel) with the UWB device and may complete payment transactions using a payment application and its wireless interface. As shown in FIG. 1B, at a given time, one or more users 58 may be in the vicinity of a UWB device (e.g., UWB device 104, 102-1, . . . , and/or 102-k). In some embodiments, the election of the primary controller (e.g., the coordinator) is completed before any UWB device can start transactions with a user device 12. In some embodiments, a UWB device (e.g., UWB device 104, 102-1, . . . , or 102-k) can sense a user device 12 when the user device 12 is in a predetermined radius/proximity of the UWB device. In this disclosure, the coordination between the primary controller and a secondary controller is implemented through wireless link 106-a, e.g., a UWB channel. For example, RCM and SIM are transmitted through wireless link 106-a.

To avoid conflict, UWB device 104 (e.g., the primary controller or coordinator) may coordinate the slot allocation for each of UWB devices 102-1, . . . , 102-k (e.g., secondary controllers or controlees). A user device 12 may communicate with a respective UWB device (UWB device 104, 102-1, . . . , or 102-k) for a plurality of (e.g., at least 5) hybrid ranging rounds before transactions are completed. The time period to complete the transactions for a user device 12 is referred to as a session, which typically includes multiple of hybrid ranging rounds (e.g., 5). In each hybrid ranging round, UWB device 104 may allocate slots to each of UWB devices 102-1, . . . , 102-k at the beginning of the hybrid ranging round. Each of UWB devices 102-1, . . . , and 102-k then has its dedicated CAP phase, CFP phase, and data phase to perform transactions in this hybrid ranging round.

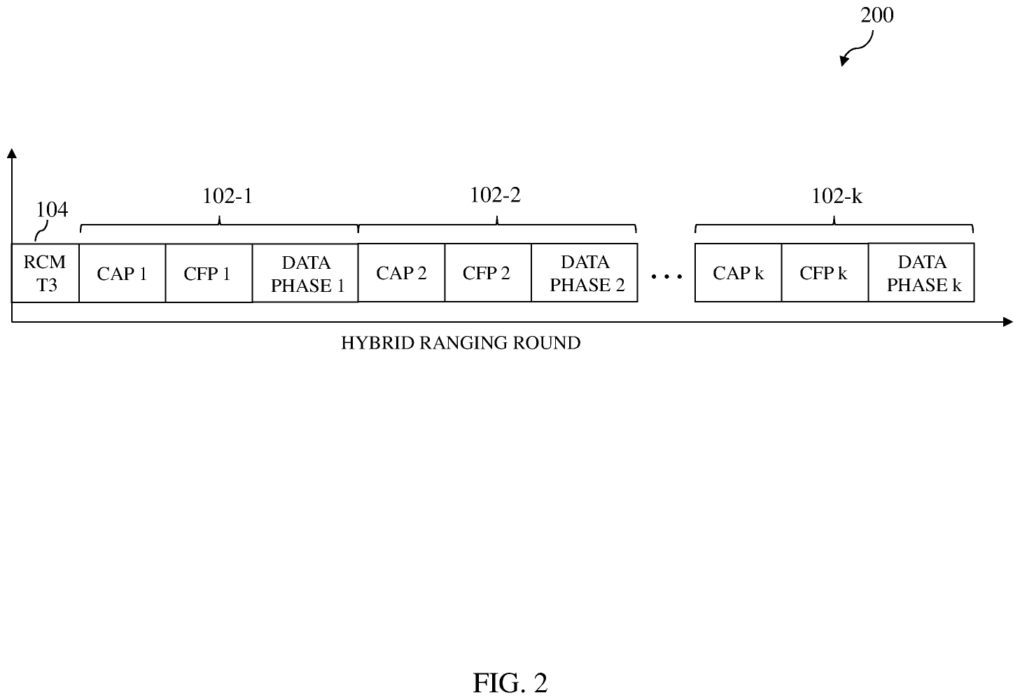

FIG. 2 illustrates a hybrid ranging round 200 with phases allocated to different UWB devices in related art. As shown in FIG. 2, the primary controller (e.g., UWB device 104) may transmit a RCM (e.g., “RCM T3”) at the beginning of hybrid ranging round 200 to allocate slots for secondary controllers (e.g., UWB device 102-1, . . . , and/or 102-k). In some embodiments, UWB device 104 may allocate slots for phases CAP 1, CFP 1, and data phase 1 for UWB device 102-1; CAP 2, CFP 2, and data phase 2 for UWB device 102-2, . . . , and CAP k, CFP k, and data phase k for UWB device 102-k in the RCM T3. Each of UWB devices 102-1, . . . , 102-k may discover new user devices (e.g., user device 12) in its radius/proximity in its CAP phase, range user devices that have been discovered in a previous CAP phase (e.g., to determine if they are to make a payment based on the distance) in its CFP phase, and perform authentication and/or payment transactions from a ranged user device in the data phase. In the second hybrid ranging round following hybrid ranging round 200, the primary controller may transmit another RCM (e.g., “RCM T3”) at the beginning of the second hybrid ranging round to allocate slots for UWB device 102-1, . . . , 102-k, for phases for each of the UWB devices (e.g., 102-1, . . . , 102-k). The number of lots allocated to a phase of a UWB device (e.g., 102-1, . . . , or 102-k) is predetermined or static, meaning the primary controller has no knowledge of the UWB device's actual needs for slots for the second hybrid ranging round, and thus does not allocate slots according to the needs of the UWB device in the second hybrid ranging round. For example, the number of user devices to be ranged by one UWB device may increase in the second ranging round, and the slots allocated using the static coordination cannot accommodate the increased number of user devices. As a result, some user devices may be ranged in the third ranging round, resulting in a potential delay of payment. In the meantime, the number of user devices at another UWB device to be ranged or to be moved to data phase may decrease or stay at a low number such that the slots allocated to the other UWB device using the static coordination may not be fully used in the second hybrid ranging round, resulting in a waste of resources. The lack of optimization of slot allocation can negatively impact the user experience.

The present disclosure provides a feedback mechanism that allows the primary controller to adjust slots allocated for each phase of a secondary controller based on the secondary controller's needs. To implement the feedback mechanism, the primary controller (e.g., UWB device 104) may, at the beginning of a hybrid ranging round, transmit a ranging control message (RCM) to allocate at least one slot to each of the secondary controllers (e.g., 102-1, . . . , 102-k) in the environment (e.g., environment 101). A secondary controller may determine its needs for slots for one or more of the CAP phase, CFP phase, and data phase in the next hybrid ranging round based on the number of user devices and/or activities in one or more of its phases in this hybrid ranging round. The secondary controller may then transmit, to the primary controller, a SIM in the allocated slot(s) by the end of this hybrid ranging round or via an Out-Of-Band connection such as BLE. The SIM, a new signaling message, may include an estimated number of slots the secondary controller needs, as determined by the secondary controller, in the next hybrid ranging round. Receiving the SIM, the primary controller may then determine the number of slots for each phase for each secondary controller for the future/next hybrid ranging round, and may transmit, in another RCM, the determined number of slots for the respective phases of each secondary controller at the beginning of the next hybrid ranging round. The secondary controller may then perform transactions in the updated allocated slots in the next hybrid ranging round.

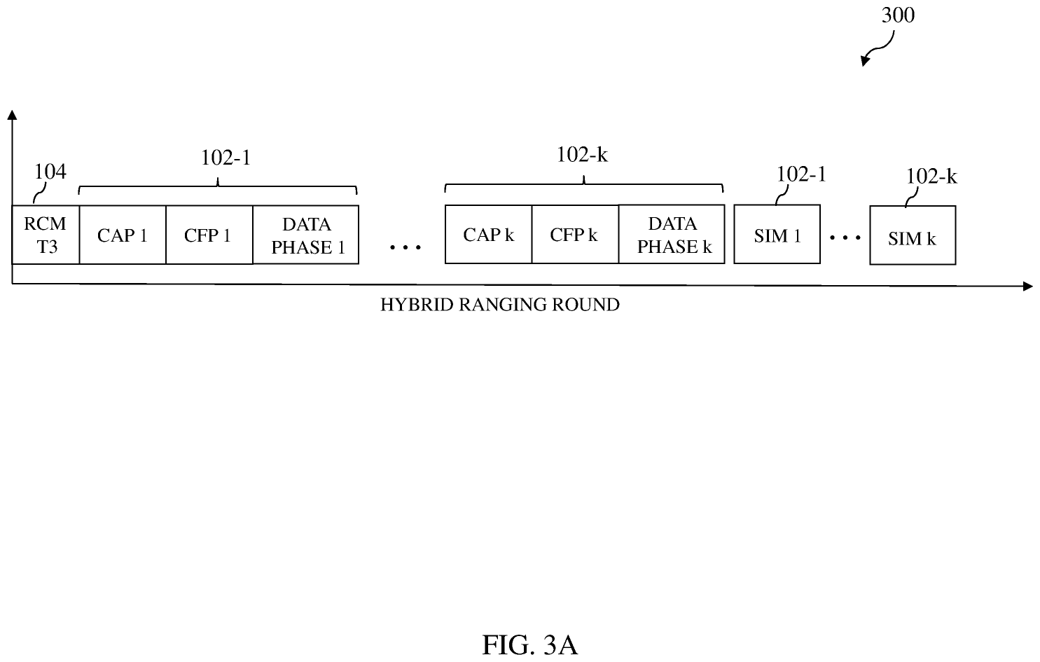

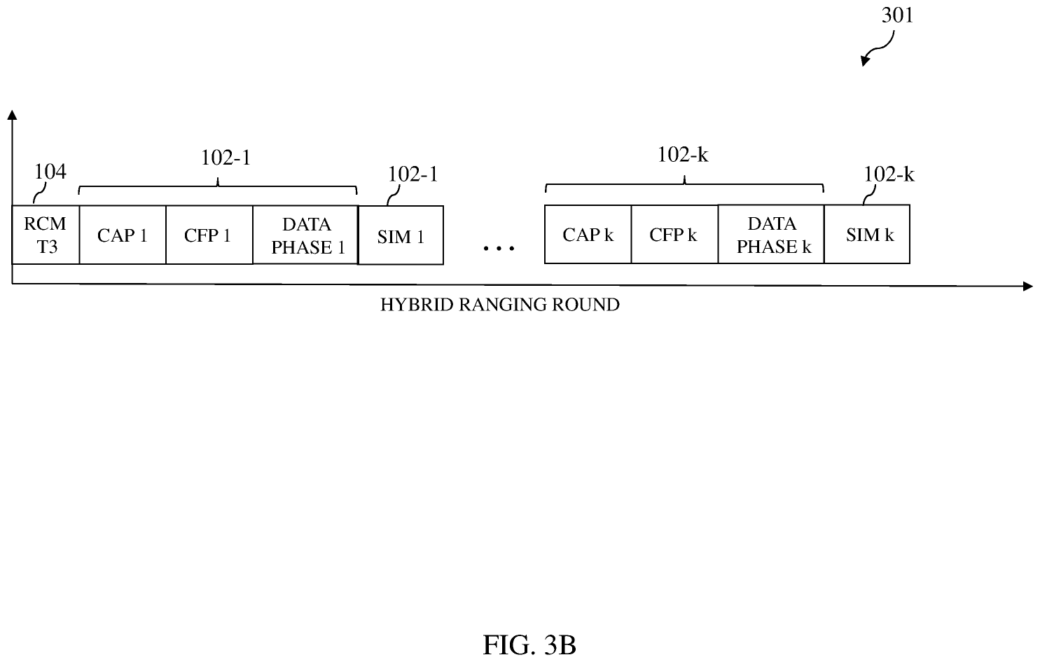

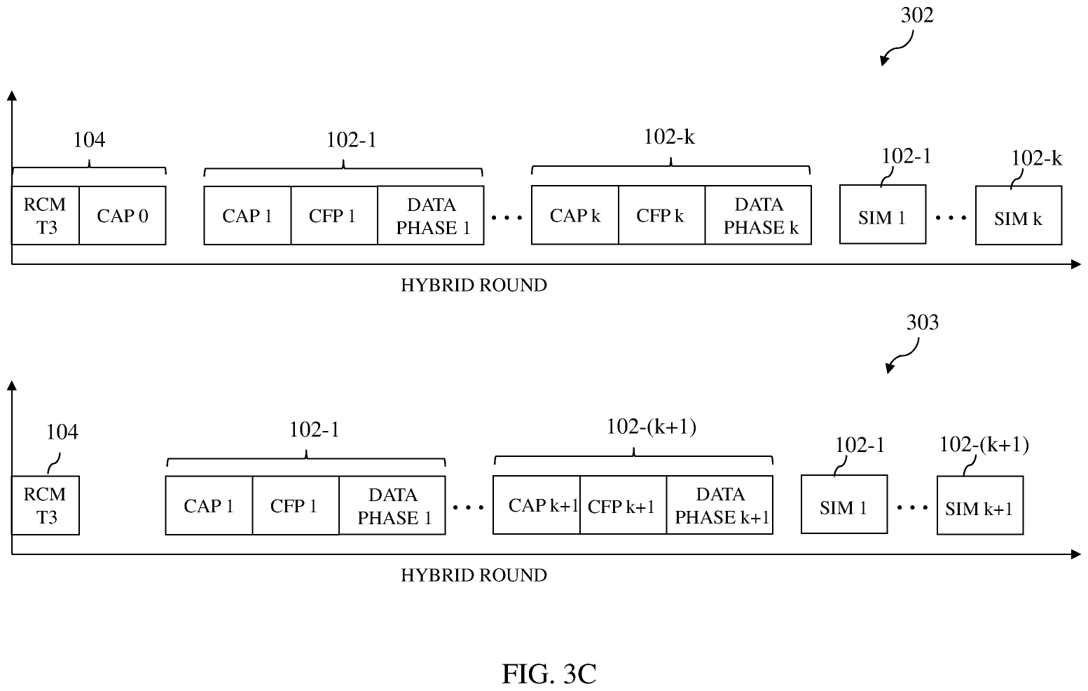

FIGS. 3A-3D illustrate hybrid ranging rounds with phases and slots allocated to different UWB devices, according to embodiments of the present disclosure. FIG. 3A illustrates an exemplary hybrid ranging round 300 with SIM's for a secondary controller to request for the number of slots needed for a future (e.g., next) hybrid ranging round, according to some embodiments. As shown in FIG. 3A, the primary controller (e.g., UWB device 104) may transmit a RCM (“RCM T3”) to the secondary controllers (e.g., UWB devices 102-1, . . . , and 102-k) (e.g., through wireless link 106-a) at the beginning of hybrid ranging round 300 to allocate slots to each secondary controller. The slots allocated to each secondary controller may include the slots for each phase (e.g., CAP phase, CFP phase, and data phase) of the secondary controller, and a slot for the secondary controller to transmit a SIM. The secondary controllers, receiving the RCM, may perform respective transactions in the allocated slots. After the respective phases (e.g., CAP phase, CFP phase, and data phase), at least one (e.g., each) of secondary controllers 102-1, . . . , 102-k may estimate the number of slots needed for the next ranging round (e.g., through slot control application 108), and transmit a request for the estimated number of slots in the respective SIM (e.g., SIM 1, . . . , SIM k) to the primary controller at the end of hybrid ranging round 300. In some embodiments, at the end of hybrid ranging round 300 (e.g., after the primary controller receives the SIMS), the primary controller may receive and acknowledge the actual needs for each phase of all the secondary controllers (e.g., 102-1, . . . , 102-k). The primary controller may then determine (e.g., through coordinator application 134) the number of slots for each phase for each secondary controller for the future/next hybrid ranging round, and send the updated slot allocation in the RCM at the beginning of the future/next hybrid ranging round.

In an example, the secondary controller may determine that it needs more slots for its CAP phase (e.g., it has detected colliding responses in the preceding hybrid ranging rounds) or less slots for its CAP phase (e.g., very few user devices have been discovered in the current hybrid ranging rounds). In another example, the secondary controller may determine that it needs more slots to create a CFP phase (e.g., a new user device has been discovered in the current hybrid ranging round), and/or needs to increase the number of slots of the CFP phase (e.g., a new user device is discovered and its intent should be assessed in parallel with other user devices). The secondary controller may also determine to reduce the number of slots for the CFP phase (e.g., a user device is moved into the data phase and the secondary controller does not need more slots to make any ranging measurement) or to close the CFP phase. In some embodiments, the secondary controller may determine it needs more slots for its data phase (e.g., to trigger the authentication procedure). The secondary controller may determine how many slots it needs (e.g., knowing the delay of the request/response of the added user device), or if it can close the data phase (e.g., all the user devices have completed their authentication/payment procedure).

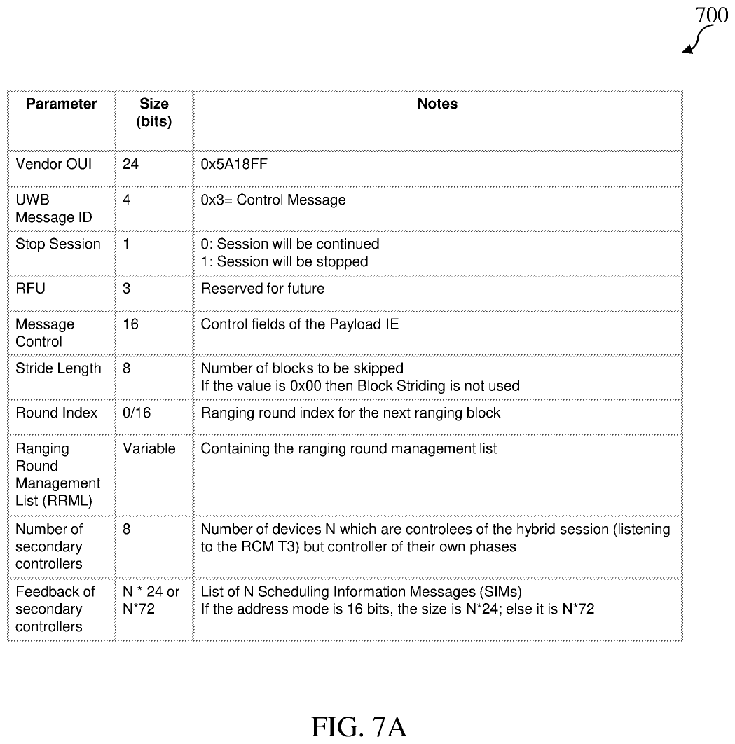

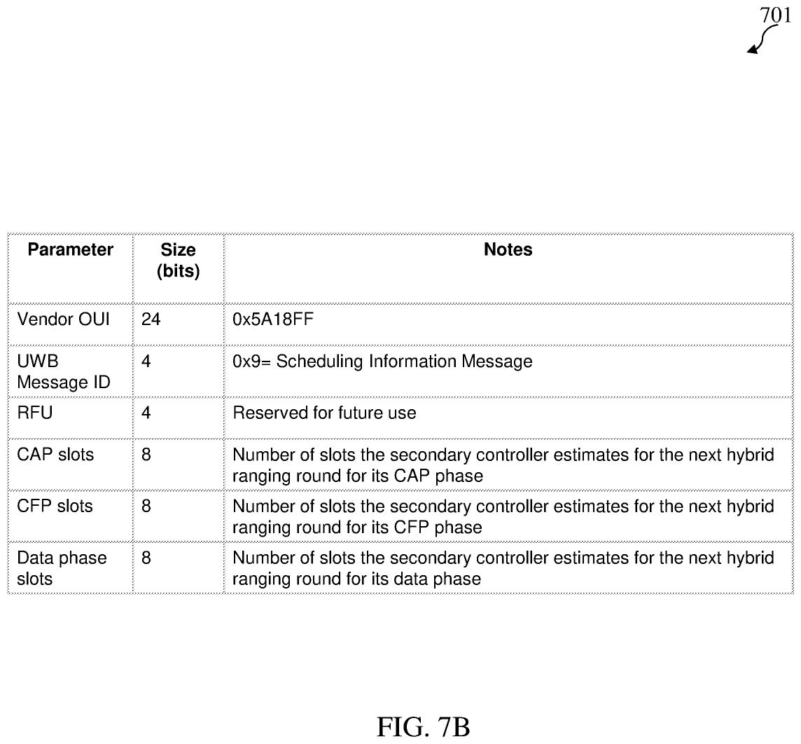

FIG. 7A illustrates an exemplary RCM 700 employed in the hybrid ranging rounds of the present disclosure, according to some embodiments. FIG. 7B illustrates an exemplary SIM 701 employed in the hybrid ranging rounds of the present disclosure, according to some embodiments. RCM 700 may be an example of the RCM T3 illustrated in the embodiments of the present disclosure, and may be employed to allocate at least one slot to each secondary controller for the secondary controller to send an estimated number of slots needed for each phase in the future/next hybrid ranging round in a SIM. As shown in FIG. 7A, RCM 700 may include a plurality of fields for controlling the coordination between the primary controller and the secondary controllers. In some embodiments, RCM 700 includes a field of “Ranging Round Management List (RRML)” that is designated to allocate slots for each phase to a respective secondary controller. In some embodiments, RCM 700 includes a field of “number of secondary controllers” that is designated to include the number of secondary controllers in the environment (e.g., environment 101). RCM 700 may also include a field of “feedback of secondary controllers” that is designated to include a list of the number of SIM's (or slots) linked to the respective addresses of the secondary controllers.

SIM 701 may be an example of the SIM's illustrated in the embodiments of the present disclosure. As shown in FIG. 7B, SIM 701 may include fields for “CAP slots,” “CFP slots,” and “data phase slots.” In some embodiments, each of these fields includes a request for an estimated number of slots for the future/next ranging round for the respective phase. The primary controller, after receiving the SIM's from the secondary controllers, may then determine the number of slots for each phase for each secondary controller for the future/next hybrid ranging round. In some embodiments, the primary controller may determine the number of slots based on certain criteria such as optimizing the average payment time, not exceeding a max payment time, etc. A detailed description of the criteria is provided below. In some embodiments, the primary controller may allocate the determined slots in the RCM at the beginning of the next hybrid ranging round for the next ranging round. In some embodiments, primary controller may indicate in advance the allocated slots for a later hybrid ranging round in a RCM, e.g., it may indicate the allocated slots for hybrid ranging round n+2 in a RCM sent at the beginning of hybrid ranging round n+1.

FIG. 3B illustrates another exemplary hybrid ranging round 301 with SIM's for a secondary controller to request for the number of slots needed for a future (e.g., next) hybrid ranging round, according to some embodiments. Different from hybrid ranging round 301, the RCM may allocate a slot to each secondary controller after the phases (e.g., CAP phase, CFP phase, and data phase) of one secondary controller but before the phases of another secondary controller. Accordingly, one or more of the secondary controllers (e.g., UWB devices 102-1, . . . , and/or 102-k) may transmit a request for the estimated number of slots in the respective SIM (e.g., SIM 1 102-1, . . . , SIM k 102-k) to the primary controller (e.g., UWB device 104) after its respective phases and before the phase of another secondary controller.

In some embodiments, in a hybrid ranging round such as 300 and 301, a primary controller may also allocate its own CAP phase, CFP phase, and/or data phase phases, together with the phases of the secondary controllers. For case of illustration, the phases of the primary controller are referred to as CAP 0, CFP 0, and data phase 0. They can be allocated in any suitable position in the hybrid ranging round, depending on the primary controller. For example, they can be allocated after RCM T3 and before CAP 1, CFP 1, and data phase 1, although not shown in FIGS. 3A and 3B.

FIGS. 3C and 3D illustrate exemplary hybrid ranging rounds 302 and 303 with SIM's for a secondary controller to request for the number of slots needed for a future (e.g., next) hybrid ranging round, according to some embodiments. In some embodiments, hybrid ranging round 303 is immediately subsequent to (e.g., the next of) hybrid ranging round 302. Different from hybrid ranging rounds 301 and 300, in hybrid ranging rounds 302 and 303, the primary controller (e.g., UWB device 104) may allocate a CAP phase (“CAP 0”) for itself to discover new secondary controllers in hybrid ranging round 302 (e.g., through wireless link 106-a), and allocate slots (e.g., including the slots for phases and for SIM) to the newly discovered secondary controller (e.g., through wireless link 106-a). In some embodiments, the primary controller may not allocate a CFP phase or a data phase for itself. Referring back to FIG. 1C, the primary controller (e.g., UWB device 104) may transmit a poll 152 that includes a window size of CAP 0. UWB device 102-(k+1), originally not in the environment (e.g., environment 101), may select a random slot (in block 156) in the CAP 0 and transmit to the primary controller a response frame 154 after a time of reply T_{reply}. The response frame 154 may include information such as time of reply T_{reply} and an identifier of UWB device 102-(k+1). If the primary controller accepts UWB device 102-(k+1) as a secondary controller through the identifier, the primary controller may obtain the identifiers of the CAP phase, CFP phase, and data phase created by UWB device 102-(k+1). In some embodiments, the primary controller obtains the identifiers of these phases UWB device 102-(k+1) through one or more non-UWB technologies (e.g., out-of-band technologies) such as WiFi and/or BLE, etc.

Referring back to FIG. 3C, after discovering UWB device 102-(k+1) in hybrid ranging round 302, the primary controller (e.g., UWB device 104) may coordinate the phases of UWB device 102-(k+1) in hybrid ranging round 303. For example, the primary controller may transmit a RCM at the beginning of hybrid ranging round 303 to allocate slots to UWB device 102-(k+1) (e.g., through wireless link 106-a). As an example, the primary controller may allocate slots for CAP (k+1) phase, CFP (k+1) phase, data phase (k+1), and SIM (k+1). In some embodiments, the primary controller may allocate the slots based on predetermined/default values in hybrid ranging round 303 (e.g., the first hybrid ranging round after UWB device 102-(k+1) is discovered), and may dynamically adjust the slots allocated to UWB device 102-(k+1) based on the feedback received in SIM (k+1). In various embodiments, SIM (k+1) can be allocated to be at the end of the respective hybrid ranging round, and/or immediately after CAP (k+1) phase, CFP (k+1) phase, and data phase (k+1) but before the phases of another secondary controller. It should be noted that, the orders of CAP (k+1) phase, CFP (k+1) phase, data phase (k+1), and SIM (k+1) are only illustrative, and they can be placed in any suitable position of the queue.

Compared to the other feedback mechanisms in related art, methods of the present disclosure have the following distinguishing features. First, a secondary controller does not indicate what it needs in the current hybrid ranging round but what its needs for its phases in the next hybrid ranging round. The number of estimated slots needed is not determined by the amount of data pending transmission but by the number of slots which are needed to optimize the number of user devices and the payment transaction time. In some embodiments, the volume of data for transactions has little or no impact on the estimated number of slots needed in this disclosure. Also, what is reported/requested by each secondary controller to the primary controller, and what information is used for by the primary controller to adjust the slot allocation, are each different from the feedback mechanism between a cell phone and a cellular base station. In the disclosure, the report/request is indeed built in a 2-level hierarchy algorithm. In a first step, the secondary controller may analyze what has occurred within each own phase (e.g., the user device number for each phase, the activities of the user devices, etc.) and then may determine the number of slots needed for respective phases in the future/next ranging round.

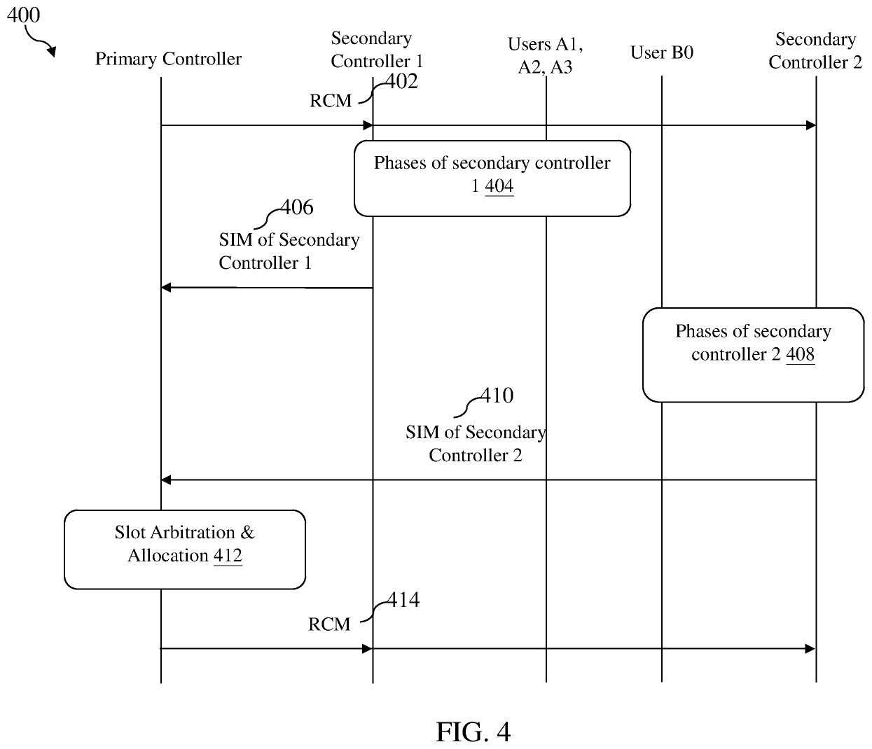

FIG. 4 illustrates a signaling diagram 400 in which secondary controllers communicating with the primary controller for implementing dynamic coordination, according to some aspects of the present disclosure. At the beginning of a hybrid ranging round, the primary controller (e.g., UWB device 104) may transmit a RCM T3402 including the session identifier, the addresses of the secondary controllers (e.g., UWB devices 102-1, . . . , 102-k) in the environment (e.g., environment 101), and the slots allocated to each of the secondary controllers. Referring back to the description of FIG. 3B, secondary controller 1 may conduct UWB transactions with users A1, A2, and A3 in “phases of secondary controller 1 (block 404),” and may send a “SIM of secondary controller 1 406” after its phases are completed. Secondary controller 2 may conduct UWB transactions with user B0 in “phases of secondary controller 2 (block 408),” and may send a “SIM of secondary controller 2 410” after its phases are completed. As described before, SIM's of secondary controllers 1 and 2 may respectively include the estimated number of slots secondary controller 1 or 2 determines for the next hybrid ranging round. Receiving the SIM's of secondary controllers 1 and 2, the primary controller may determine the slot allocation (“slot arbitration & allocation 412”) for secondary controllers 1 and 2 for the next hybrid ranging round. At the beginning of the next hybrid ranging round, the primary controller may transmit a RCM T3 414 including the session identifier, the addresses of the secondary controllers in the environment (e.g., environment 101), and the updated number of slots allocated to each of the secondary controllers.

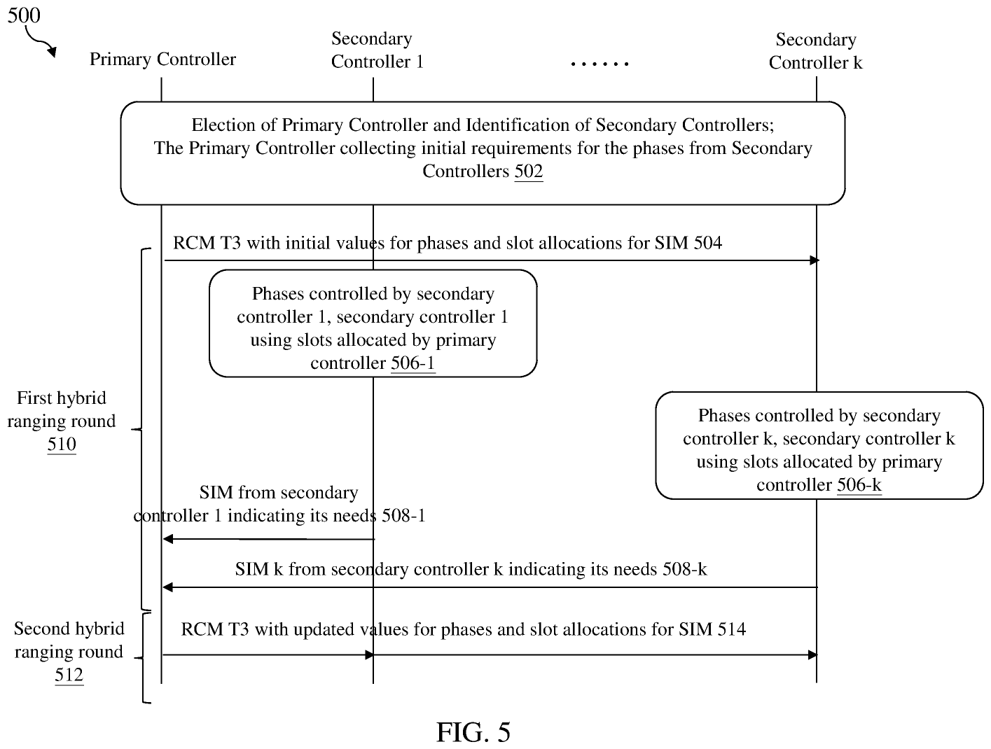

FIG. 5 illustrates another signaling diagram 500 in which secondary controllers communicating with the primary controller for implementing dynamic coordination, according to some aspects of the present disclosure. Before the primary controller coordinates the secondary controllers, the UWB devices (e.g., UWB devices 104, 102-1, 102-k) may elect the primary controller (e.g., UWB device 104) and the secondary controllers (e.g., UWB devices 102-1, . . . , 102-k), e.g., by exchanging configuration parameters (in block 502). The primary controller may collect initial requirements (e.g., types and/or sizes) for the phases from the secondary controllers. For example, the primary controller may schedule a CAP phase (e.g., CAP 0) to discover any new secondary controllers in the proximity, referring back to the description of FIG. 3C. Then, at the beginning of the first hybrid ranging round 510, the primary controller (e.g., UWB device 104) may transmit a RCM 504 (e.g., “RCM T3”) including the initial values for phases, and the slots allocated for SIM (if the SIM are sent back to the coordinator via in-band UWB messages) to each of the secondary controllers. Each of the secondary controllers (e.g., secondary controllers 1-k) may use the slots allocated in the RCM, and control its respective phase to conduct UWB transactions with one or more user devices 12. For example, secondary controller 1 may perform transactions with user devices 12 in its proximity in the phases (e.g., CAP 1, CFP 1, data phase 1) allocated in RCM 504 and controlled by itself (in block 506-1), . . . , and secondary controller k may perform transactions with user devices 12 in its proximity in the phases (e.g., CAP k, CFP k, data phase k) allocated in RCM 504 and controlled by itself (in block 506-k). Referring back to the description of FIG. 3C, after the phases of all secondary controllers are completed, each secondary controller may send a respective SIM, indicating its estimated number of slots needed for the next hybrid ranging round. For example, secondary controller 1 may transmit a SIM 508-1, indicating its needs of slots for the next hybrid ranging round, to the primary controller; . . . , secondary controller k may transmit a SIM 508-k, indicating its needs of slots for the next hybrid ranging round, to the primary controller. In response, at the beginning of the second hybrid ranging round 512, the primary controller may transmit a RCM 514 (“RCM T3”) including the updated number of slots, e.g., for the phases and SIM, allocated to each of the secondary controllers.

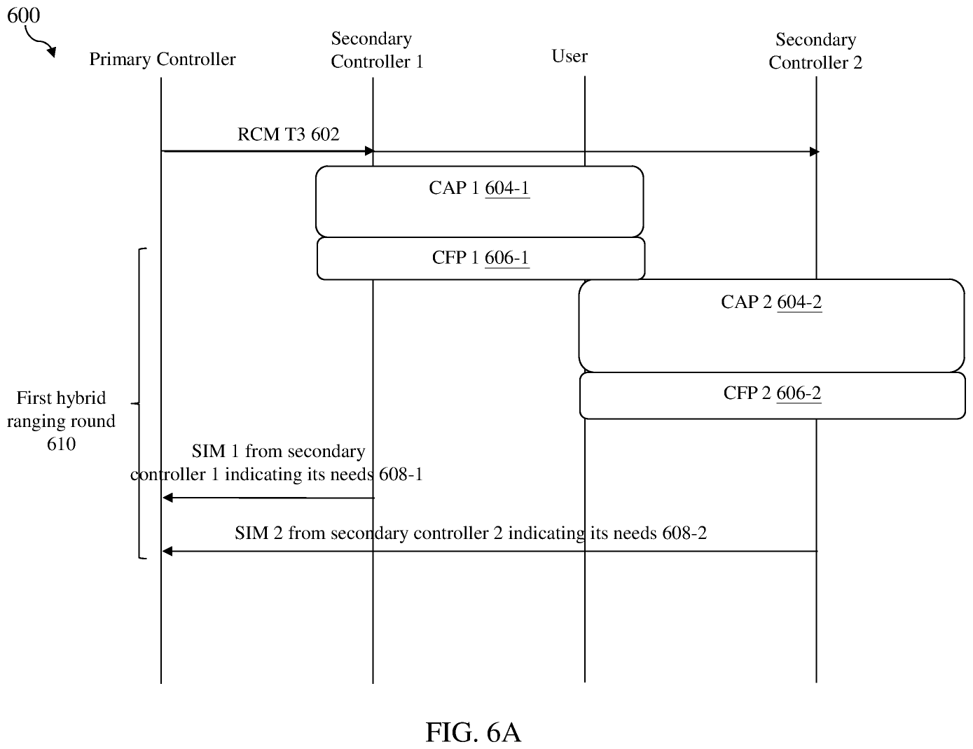

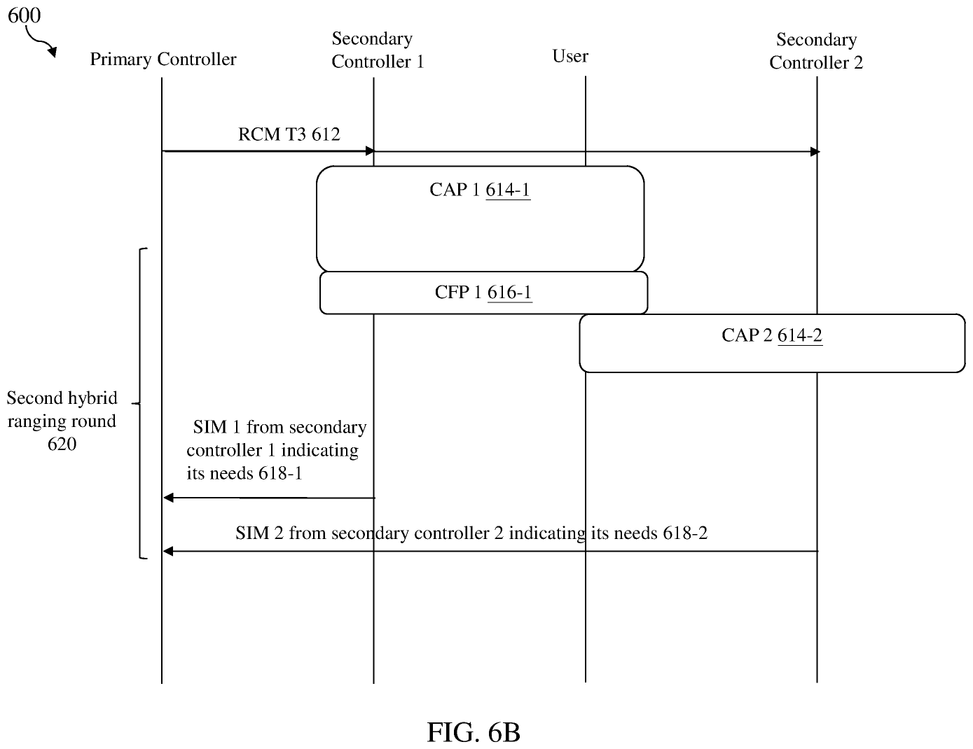

FIGS. 6A and 6B illustrate other signaling diagrams 600 in which secondary controllers communicating with the primary controller for implementing dynamic coordination, according to some aspects of the present disclosure. As shown in FIG. 6A, in a first hybrid ranging round 610, after the allocation of slots by the RCM 602 (“RCM T3”) from the primary controller, secondary controller 1 may detect, in its CAP 1 phase 604-1, a plurality of new user devices (e.g., user devices 12) that are potentially to be included in its CFP 1 phase of the next hybrid ranging round for ranging (e.g., a double-sided two way ranging sub-session). Secondary controller 1 may also detect collision in CAP 1 phase 604-1, and may determine it needs more slots allocated for CAP 1 phase and CFP 1 phase in the next hybrid ranging round. Secondary controller 2 may not detect any new user devices in CAP 2 phase 604-2 and all the user devices of CFP 2 phase 606-2 have completed ranging. Secondary controller 2 may determine, for the next hybrid ranging round, it needs fewer slots for CAP 2 phase and can temporarily release its CFP 2 phase. At the end of the first hybrid ranging round 610, secondary controller 1 may send a SIM 1 (i.e., 608-1) to the primary controller, indicating its need for more slots for next CAP 1 phase and CFP 1 phase, respectively. Secondary controller 2 may send a SIM 2 (i.e., 608-2) to the primary controller, indicating it needs fewer slots for next CAP 2 phase and zero slots for CFP 2 phase. The primary controller may determine the slots allocated to secondary controllers 1 and 2 for the second hybrid ranging round based on certain criteria (described below). The primary controller may then update the slot allocation based on the received SIM's from second controllers 1 and 2.

As shown in FIG. 6B, at the beginning of the second hybrid ranging round 620, the primary controller may transmit a RCM 612 to each of secondary controllers 1 and 2, indicating the updated slot allocation based on the actual needs of secondary controllers 1 and 2. For example, secondary controller 1 may be allocated more slots for CAP 1 phase 614-1, but its slots for CFP 1 phase 616-1 remains unchanged. Secondary controller 2 may be allocated fewer slots for CAP 2 phase 614-2 and zero slots for CFP 2 phase (e.g., thus not shown in FIG. 6B). Each secondary controllers 1 and 2 may then conduct UWB transactions with user devices in the respective phases. At the end of the second hybrid ranging round, secondary controller 1 may send a SIM 1 (i.e., 618-1) to the primary controller, indicating its need for more slots for CFP 1 phase and maintaining the number of slots for CAP 1 phase. Secondary controller 2 may send a SIM 2 (i.e., 618-2) to the primary controller, indicating maintaining the number of slots for CAP 2 phase and zero slots for CFP 2 phase. The primary controller may update the slot allocation for a third hybrid ranging round (not shown) based on certain criteria (described in detail below).

In some embodiments, if the primary controller determines the duration of a hybrid ranging round is not long enough (e.g., for adding more slots for some secondary controllers), the primary controller may reduce the CAP sizes (e.g., slots allocated to one or more CAP phases) for one or more secondary controllers even after receiving SIM's requesting for more slots from these secondary controllers. The intent is that the started payment transactions (e.g., with a user device already discovered in a CAP phase, with a user device already in a CFP phase, and/or with a user device already running the Authentication in a data phase) have higher priority to continue. Delay the start of the payment procedure with user devices 12 that are not immediately discovered may be acceptable (e.g., because the CAP size is too small and the Ranging Response Messages of 2 user devices 12 may collide).

As described previously, in some embodiments, a secondary controller may include three phases in a hybrid ranging round. The three phases may include one CAP phase to discover new user devices, one CFP phase for secure ranging between a discovered user device and the secondary controller, and one data phase (e.g., date-only phase) for data transaction (e.g., payment). In some embodiments, a secondary controller may include a different number of phases in a hybrid ranging round. For instance, two phases/phases, e.g., including one CAP phase and one data and ranging phase. In another example, a secondary controller may include one phase to allow coordination of simple ranging. The number of phases assigned to a secondary controller in a hybrid ranging round can vary in different embodiments, and should not be limited by the embodiments of the present disclosure.

In embodiments of the present disclosure, a secondary controller may have certain criteria to determine the estimated number of slots needed for the future/next hybrid ranging round. The criteria are described below.

In some embodiments, a secondary controller may determine the number of slots allocated for a CAP phase to be no less than a minimum CAP slot number (e.g., the minimum number of slots required to be allocated to a CAP phase), to discover new user devices. In some embodiments, the minimum CAP slot number is 5.

In some embodiments, if a secondary controller detects some failed responses in its CAP phases (e.g., because the POS is very crowded and a high number of user devices causes some response collision), the secondary controller may request (e.g., in its SIM) for a larger size of the CAP window (e.g., the number of slots in the CAP phase) in the next hybrid ranging round. If the secondary controller detects very few responses with regards to the size of the CAP window, the secondary controller may request a smaller CAP window for the next hybrid ranging round. The criteria to determine the requested number of slots for the CAP phase may include the following:

In some embodiments, if the number of responses is greater than θ1×CAP Size (n) (e.g., there are many user devices to be discovered), then CAP size (n+1)=min (Max CAP size, CAP size (n)+Δup), where CAP size (n) represents the number of slots in a hybrid ranging round n, CAP size (n+1) represents the number of slots in a hybrid ranging round (n+1), 0≤θ1<1 is a threshold to increase the CAP size in the next hybrid ranging round, Max CAP size is the maximum number of slots that can be allocated to CAP phase, and Δup is the increase step (e.g., 1, 2, . . . ). θ1 can be the threshold about which there is a high probability of UWB response collisions and many user devices may not be discovered.

In some embodiments, if the number of responses is less than θ2×CAP Size (n) (e.g., there are very few user devices to be discovered), then CAP size (n+1)=max (5, CAP size (n)-Δdown), where 0≤θ2<θ1, θ2 is another threshold to decrease the CAP size in the next hybrid ranging round, and Adown is the increase step (e.g., 1, 2, . . . ). If the secondary controller detects a new user device in the CAP phase, the secondary controller may move this newly discovered user device into the CFP phase of the next hybrid ranging round. If there is no other user devices participating in the CFP phase (or if the user devices participating in the current CFP phases are to be moved into the data phase of the next hybrid ranging round), the secondary controller may request the number of slots allocated to the CFP phase of the next hybrid ranging round to be 5 (or any other suitable number), which is the typical number of messages of a deferred CFP phase with only one responder, or set the number of slots allocated to the CFP phase of the next hybrid ranging round to be 4 if the CFP phase is a non-deferred CFP phase. If a user device participating in the CFP phase is held in the CFP phase by the secondary controller in the next hybrid ranging round (e.g., because another ranging measurement needs to be done to confirm the payment distance or intention), the secondary controller may request to increase the number of slots allocated to the CFP phase of the next hybrid ranging round by an incremental number such as 1, such that the secondary controller can schedule a slot for Ranging Response Message for the added user device and the user device which has been already in the CFP). If a user device participating in the CFP phase is to be moved into the data phase by the secondary controller in the next hybrid ranging round, the secondary controller may not request to change the number of slots allocated to the CFP phase (e.g., because the number of user devices participating in the next CFP phase is unchanged or not increased).

For example, the secondary controller may determine CFP user devices (n+1)=CFP user devices (n)+user devices discovered in CAP (n)—user devices to be moved into the data phase (n). In this equation, user device (n+1) represents the change of the number of user devices to participate in hybrid ranging round (n+1), CFP user devices (n) is the number of user devices participating in the CFP (n) (e.g., Secure Ranging TWR) of hybrid ranging round n, user devices discovered in CAP (n) is the number of user devices that have been discovered in CAP (n) and will be moved into the CFP (n+1) of hybrid ranging round (n+1), and user devices to be moved into the data phase (n) is the number of user devices whose payment intention is completed and to be removed from the CFP (n+1) of hybrid ranging round (n+1). In some embodiments, CFP user devices (n+1)=max (8, user devices (n+1)). If CFP (n+1)>0 (e.g., there is at least one user device to participate in the CFP phase in the next hybrid ranging round), the requested number of slots for next CFP phase may be equal to (5+CFP user devices (n+1)). For other scenarios, (e.g., no user device is to participate in the CFP phase in the next hybrid ranging round), the requested number of slots for next CFP phase may be 0.

If the secondary controller does not detect any new user device and if the secondary controller moves the last user device of the CFP (n) into the data phase (n+1), the requested number of slots for the next CFP phase may be 0. In some embodiments, the primary controller may allocate the slots for CFP phase from one secondary controller to another secondary controller, and to release CFP phase from the one secondary controller. If the secondary controller does not detect any new user device and if the secondary controller is to move an user device of CFP (n) into the data phase (n+1), the secondary controller may request to decrease the number of slots allocated for CFP (n+1) by a suitable number (e.g., 1).

In some embodiments, if the secondary controller determines to quit the hybrid ranging session/round, it can indicate to the primary controller that it does not require any more slot in the CAP phase, CFP phase, or data phase in the hybrid ranging round (n+1). The primary controller may determine, from such indication that the secondary controller wants to quit. The primary controller may not allocate any slots to the phases of the secondary controller, and may remove the identifiers of the phases from the hybrid ranging session/round.

In some embodiments, if the secondary controller moves a user device from CFP (n) into the data phase (n+1) of the next hybrid ranging round, and if there is no other user device participating in any data transfer (e.g., no data phase (n)), the second controller may request the primary controller to activate its data phase and allocate N slots for the data phase (n+1). In some embodiments, the value of N depends typically on the request/response delay of the user device and may be equal to 1, 2, . . . . In some embodiments, if there is already an user device in the data phase (n) and the secondary controller will hold this user device in the data phase (n+1), or if a user device is to be removed from the data phase (n+1) (e.g., the Authentication of the user device is complete), the secondary controller may determine whether the duration of data phase (n+1) has enough slots to allow the request/response Authentication with the new user device. The secondary controller may update the value of N accordingly.

In some embodiments, if all the user devices have finished their Authentication in the hybrid ranging round n, and if no user device is to be moved from CFP (n) into the data phase (n+1), the secondary controller may request the number of slots allocated to the data phase (n+1) to be zero (e.g., N is equal to zero). The primary controller may thus release data phase (n+1) of the secondary controller, and allocate some slots to another secondary controller that need more slots.

For example, user devices in data phase (n+1)=user devices in data phase (n)-fully authenticated user devices (n)+fully ranged user devices to be added into the next data phase. In some embodiments, if user devices in data phase (n+1)>0 (e.g., there is at least one user device to participate in the data phase in the next hybrid ranging round for Authentication), the requested number of slots for the next data phase is equal to Max (Delay of Authentication Request/Response+Request Size/PDU size+Response Size/PDU size), where max applies over the selected user devices to participate in the next hybrid ranging round, and PDU stands for protocol data unit. In some embodiments, in other scenarios (e.g., no user device will participate in the data phase (n+1)), the requested number of slots for data phase (n+1) may be zero.

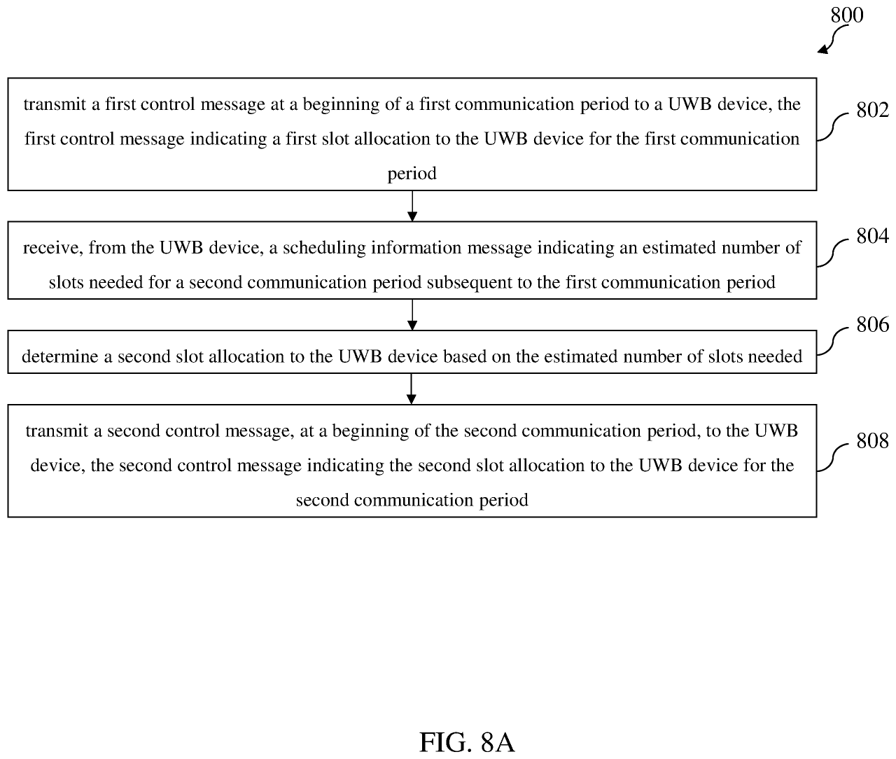

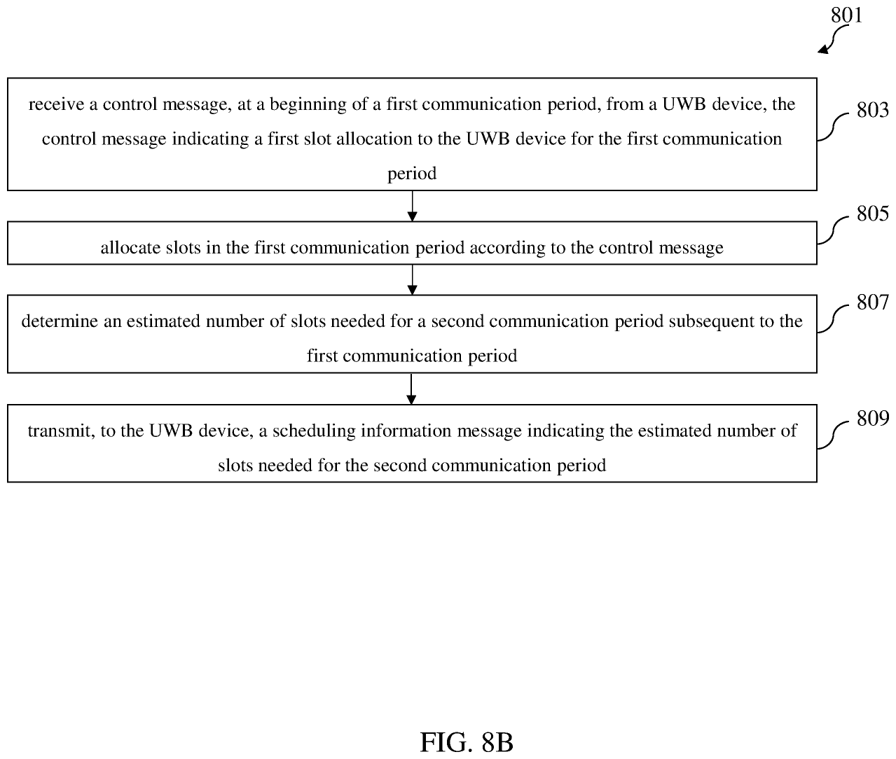

FIG. 8A is a flowchart of a method 800 for a primary controller to perform dynamic coordination in a UWB system, according to some embodiments of the present disclosure. Method 800 is merely an example, and is not intended to limit the present disclosure beyond what is explicitly recited in the claims. Additional operations can be provided before, during, and after the method 800, and some operations described can be replaced, eliminated, or moved around for additional embodiments of method 500. For ease of illustration, FIG. 8A is described in connection with FIGS. 1B, 3A-3C, 4, 5, 6A, 6B, and 7A.

At step 802, a first control message is transmitted at a beginning of a first communication period to a UWB device, the first control message indicating a first slot allocation to the UWB device for the first communication period. As shown in FIGS. 1B, 3A-3C, 4, 5, 6A, 6B, and 7A, at the beginning of a hybrid ranging round (e.g., hybrid rang round 301, 302, 303, or 304), a primary controller (e.g., UWB device 104) transmits/broadcasts a RCM (e.g., RCM T3, referring back to FIG. 7A) to secondary controllers (e.g., UWB device 102-1, . . . , or 102-n). The first control message may include a first slot allocation to the secondary controller for the first hybrid ranging round, referring back to, e.g., FIGS. 4, 5, 6A and 6B.

At step 804, a scheduling information message indicating an estimated number of slots needed for a second communication period subsequent to the first communication period is received from the UWB device. As shown in FIGS. 3A-3C, 4, 5, 6A, and 6B, the primary controller may receive a SIM from a secondary controller. The SIM may include an indication of an estimated number of slots needed for a second hybrid ranging round, referring back to FIGS. 4, 5, 6A and 6B.

At step 806, a second slot allocation to the UWB device is determined based on the estimated number of slots needed. As shown in FIGS. 4, 5, 6A, and 6B, the primary controller may determine a second slot allocation to the secondary controller. The second slot allocation is determined based on the estimated number of slots needed that is requested in the SIM.

At step 808, a second control message is transmitted at a beginning of the second communication period to the UWB device, the second control message indicating the second slot allocation to the UWB device for the second communication period. As shown in FIGS. 3A-3C, 4, 5, 6B, and 7A, the primary controller may transmit another RCM (e.g., RCM T3) at the beginning of the second hybrid ranging round to the second controller. The other RCM may indicate the second slot allocation to the secondary controller for the second hybrid ranging round.

FIG. 8B is a flowchart of a method 801 for a secondary controller to perform dynamic coordination in a UWB system, according to some embodiments of the present disclosure. Method 801 is merely an example, and is not intended to limit the present disclosure beyond what is explicitly recited in the claims. Additional operations can be provided before, during, and after the method 801, and some operations described can be replaced, eliminated, or moved around for additional embodiments of method 500. For case of illustration, FIG. 8B is described in connection with FIGS. 1B, 3A-3C, 4, 5, 6A, 6B, 7A, and 7B.

At step 803, a control message is received at a beginning of a first communication period, from a UWB device, the control message indicating a first slot allocation to the UWB device for the first communication period. As shown in FIGS. 1B, 3A-3C, 4, 5, 6A, 6B, 7A, and 7B, at the beginning of a hybrid ranging round (e.g., hybrid ranging round 300, 301, 302, or 303), a secondary controller (e.g., UWB device 102-1, . . . , or 102-k) may receive a RCM (e.g., RCM T3) from a primary controller (e.g., UWB device 104). The RCM may indicate a first slot allocation to the secondary controller for the first hybrid ranging round.

At step 805, slots in the first communication period are allocated according to the control message. As shown in FIGS. 4, 5, 6A, and 6B, the secondary controller may allocate the slots in the first hybrid ranging round according to the RCM.

At step 807, an estimated number of slots needed for a second communication period subsequent to the first communication period is determined. As shown in FIGS. 3A-3C, 4, 5, 6A, 6B, and 7B, the secondary controller may determine an estimated number of slots needed for a second hybrid ranging round subsequent to the first hybrid ranging round.

At step 809, a scheduling information message indicating the estimated number of slots needed for the second communication period is transmitted to the UWB device. As shown in FIGS. 3A-3C, 4, 5, 6A, 6B, and 7B, the secondary controller may transmit a SIM, indicated the estimated number of slots needed for the second hybrid ranging round, to the primary controller.

Those skilled in the art will recognize improvements and modifications to the preferred embodiments of the present disclosure. All such improvements and modifications are considered within the scope of the concepts disclosed herein and the claims that follow.

What is claimed is:

1. A method for scheduling control in ultra-wideband (UWB) communication, comprising:
transmitting a first control message at a beginning of a first communication period to a UWB device, the first control message indicating a first slot allocation to the UWB device for the first communication period;
receiving, from the UWB device, a scheduling information message indicating an estimated number of slots needed for a second communication period subsequent to the first communication period;
determining a second slot allocation to the UWB device based on the estimated number of slots needed; and
transmitting a second control message, at a beginning of the second communication period, to the UWB device, the second control message indicating the second slot allocation to the UWB device for the second communication period.

2. The method of claim 1, wherein the determining of the second slot allocation to the UWB device comprises one of:
reducing a number of slots allocated to the UWB device in response to the estimated number of slots needed indicating a decrease of a slot usage;
increasing the number of slots allocated to the UWB device in response to the estimated number of slots needed indicating an increase of the slot usage; or
maintaining the number of slot s allocated to the UWB device in response to the estimated number of slots needed being zero.

3. The method of claim 1, wherein:
the first communication period and the second communication period each comprises a first period for the UWB device to detect a new user device, a second period for the UWB device to perform ranging with an existing user device, and a third period for the UWB device to perform data transfer with another existing user device;
the first slot allocation comprises a command to allocate respective slots for the first period, the second period, and the third period in the first communication period; and
the second slot allocation comprises a command to allocate updated respective slots for the first period, the second period, and the third period in the second communication period.

4. The method of claim 3, wherein the scheduling information message comprises the estimated number of slots needed based on an estimated number of user devices in one or more of the first period, the second period, or the third period in the second communication period.

5. The method of claim 1, wherein the first control message further comprises an allocation of a slot to the UWB device for the transmission of the scheduling information message.

6. The method of claim 3, wherein the second slot allocation comprises a command to reduce a number of slots allocated to the first period in the second communication period in response to the estimated number of slots needed exceeding a largest number of slots that can be added to the second communication period.

7. The method of claim 1, further comprising,
after transmitting the first control message and before receiving the scheduling information message, detecting a second UWB device; and
receiving configuration information of the UWB device from a non-UWB channel, wherein the second control message further indicates a slot allocation to the second UWB device for the second communication period.

8. A method for scheduling control in ultra-wideband (UWB) communication, comprising:
receiving a control message, at a beginning of a first communication period, from a UWB device, the control message indicating a first slot allocation to the UWB device for the first communication period;
allocating slots in the first communication period according to the control message;
determining an estimated number of slots needed for a second communication period subsequent to the first communication period; and
transmitting, to the UWB device, a scheduling information message indicating the estimated number of slots needed for the second communication period.

9. The method of claim 8, further comprising:
receiving a second control message at a beginning of the second communication period, from the UWB device, the control message indicating a second slot allocation for the second communication period, the second slot allocation reflecting the estimated number of slots needed; and
allocating slots in the second communication period according to the second control message.

10. The method of claim 9, wherein the second control message comprises a command for:
reducing a number of slots allocated to the UWB device in response to the estimated number of slots needed indicating a decrease of a slot usage;
increasing the number of slots allocated to the UWB device in response to the estimated number of slots needed indicating an increase of the slot usage; or
maintaining the number of slot s allocated to the UWB device in response to the estimated number of slots needed being zero.

11. The method of claim 9, wherein:
the first communication period and the second communication period each comprises a first period for detecting a new user device, a second period for performing ranging with an existing user device, and a third period for performing data transfer with another existing user device;
the first slot allocation comprises a command to allocate respective slots for the first period, the second period, and the third period in the first communication period; and
the second slot allocation comprises a command to allocate updated respective slots for the first period, the second period, and the third period in the second communication period.

12. The method of claim 11, wherein the scheduling information message is transmitted after the third period of the first communication period or at an end of the first communication period.

13. The method of claim 11, wherein the determining of the estimated number of slots needed for the second communication period comprises:
determining a number of user devices that are active in at least one of the first period, the second period, or the third period of the first communication period;
estimating a number of user devices that are active in at least one of the first period, the second period, or the third period of the second communication period based on the number of user devices that are active in the first communication period; and
determining an estimated number of slots for at least one of the first period, the second period, or the third period of the second communication period based on the estimated number of user devices that are active in the at least one of the first period, the second period, or the third period of the second communication period.

14. The method of claim 13, wherein the determining of the estimated number of slots for at least one of the first period, the second period, or the third period of the second communication period comprises determining the estimated number slot that is greater than or equal to the number of user devices that are active in a respective period in the first communication period, and less than or equal to a maximum number of slots for the respective period.

15. The method of claim 9, wherein:
the scheduling information message comprises an indication to terminate communication with the UWB device; and
the second control message comprises a command to remove a communication identification.

16. An ultra-wideband (UWB) device, comprising:
a transceiver operable to perform a UWB communication;
a memory for storing program instructions, communication identification of another UWB device, and slot allocation for the other UWB device; and
a processor coupled to the transceiver and to the memory, wherein the processor is operable to execute the program instructions, which, when executed by the processor, cause the UWB device to perform the following to allocate slots for a subsequence communication period for the other UWB device:
transmitting a first control message, at a beginning of a first communication period, to a UWB device, the first control message indicating a first slot allocation to the other UWB device for the first communication period;
receiving, from the other UWB device, a scheduling information message indicating an estimated number of slots needed for a second communication period subsequent to the first communication period;
determining a second slot allocation to the other UWB device based on the estimated number of slots needed; and
transmitting a second control message, at a beginning of the second communication period, to the other UWB device, the second control message indicating the second slot allocation to the other UWB device for the second communication period.

17. The UWB device of claim 16, wherein the determining of the second slot allocation to the other UWB device comprises one of:
reducing a number of slots allocated to the other UWB device in response to the estimated number of slots needed indicating a decrease of a slot usage;
increasing the number of slots allocated to the other UWB device in response to the estimated number of slots needed indicating an increase of the slot usage; or
maintaining the number of slot s allocated to the other UWB device in response to the estimated number of slots needed being zero.

18. The UWB device of claim 17, wherein:
the first communication period and the second communication period each comprises a first period for the other UWB device to detect a new user device, a second period for the other UWB device to perform ranging with an existing user device, and a third period for the other UWB device to perform data transfer with another existing user device;
the first slot allocation comprises a command to allocate respective slots for the first period, the second period, and the third period in the first communication period; and
the second slot allocation comprises a command to allocate updated respective slots for the first period, the second period, and the third period in the second communication period.

19. The UWB device of claim 18, wherein the scheduling information message comprises the estimated number of slots needed based on an estimated number of user devices in one or more of the first period, the second period, or the third period in the second communication period.

20. The UWB device of claim 16, wherein the first control message further comprises an allocation of a slot to the other UWB device for the transmission of the scheduling information message.
